(19) United States
(12) Patent Application Publication
(10) Pub. No.: US 2023/0367692 A1
(43) Pub. Date: Nov. 16, 2023

(54) SYSTEMS AND METHODS FOR TESTING AND ANALYZING HUMAN MACHINE INTERFACES

(71) Applicant: AWAYR AI, INC., Cambridge, MA (US)

(72) Inventors: Adam Beal, Cambridge, MA (US); Benjamin Sawyer, Orlando, FL (US)

(21) Appl. No.: 18/318,675

(22) Filed: May 16, 2023

Related U.S. Application Data
(60) Provisional application No. 63/342,557, filed on May 16, 2022.

(51) Int. Cl. G06F 11/34; G05B 19/418

(52) U.S. Cl. CPC G06F 11/3457; G05B 19/41885

(57) ABSTRACT

Described herein are computer-implemented systems and methods of evaluating control interfaces based on user interaction. The systems and methods may include: displaying, on a display, an actual environment user interface (UI) to a user; receiving, from one or more sensors, signals indicative of a first user interaction with the displayed actual environment UI; calculating a plurality of parameters of the first user interaction with the actual environment UI based on the received signals indicative of the first user interaction; and outputting an indication for the actual user interface. In some embodiments, the plurality of parameters includes one or more of: a total eyes off road time metric, a task completion time, a subtask completion time, or a performance score. In some embodiments, the actual environment UI is a test UI of a vehicle.

### CROSS-REFERENCE TO RELATED APPLICATIONS

This application claims the priority benefit of U.S. Provisional Patent Application Ser. No. 63/342,557, filed May 16, 2022, the contents of which are herein incorporated by reference in their entirety.

### TECHNICAL FIELD

This disclosure relates generally to the field of human machine interfaces, and more specifically to the field of human machine interface design, safety, and testing. Described herein are systems and methods for testing and analyzing human machine interfaces.

### BACKGROUND

Testing human machine interfaces and user interfaces is a complex problem requiring real world scenarios that prompt real world human interactions with the interfaces.

The problem with commercially available systems is that they are complicated to install (e.g., require expert installation), have security concerns (when transmitting data over the internet is not preferable), are expensive (e.g., full-scale simulators cost thousands of dollars), are not easily shippable or are otherwise not mobile, and are poor predictors of how actual user interfaces will perform when real users are using them. Further, the data derived from currently available systems does not readily provide the ability to annotate the data or analyze the data in a collaborative environment, often because current systems store the data in individual files which are difficult to collectively share, analyze, and annotate.

Accordingly, there exists a need for new systems and methods for testing and evaluating human machine and user interfaces.

### BACKGROUND

In some aspects, the techniques described herein relate to a computer-implemented method of evaluation a control interface based on user interaction, including: displaying, on a display, an actual environment user interface (UI) to a user, wherein the actual environment UI is a test UI of a vehicle; receiving, from one or more sensors, signals indicative of a first user interaction with the displayed actual environment UI; calculating a plurality of parameters of the first user interaction with the actual environment UI based on the received signals indicative of the first user interaction, wherein the plurality of parameters include one or more of: a total eyes off road time metric, a task completion time, a subtask completion time, or a performance score; and outputting an indication for the actual user interface.

In some aspects, the techniques described herein relate to a computer-implemented method of evaluating control interfaces based on user interactions in simulated and actual environments, including: displaying, on a display, a simulated environment user interface (UI) to a user, wherein the simulated environment UI represents a test UI of a vehicle; receiving, from one or more sensors, signals indicative of a first user interaction with the displayed simulated environment UI; calculating a plurality of parameters of the simulated environment UI based on the received signals indicative of the first user interaction, wherein the plurality of parameters include one or more of: a total eyes off road time metric, a task completion time, a subtask completion time, or a predictive score; displaying, on the display or a second display, an actual environment UI to the user, wherein the displayed actual environment UI corresponds to the displayed simulated environment UI, and wherein the actual environment UI is the test UI of the vehicle; receiving, from one or more sensors, signals indicative of a second user interaction with the displayed actual environment UI; calculating a second plurality of parameters of the actual environment UI based on the received signals indicative of the second user interaction, wherein the second plurality of parameters include one or more of: a total eyes off road time metric, a task completion time, a subtask completion time, or a predictive score; comparing the first plurality of parameters to the second plurality of parameters; and outputting an indication for one or both of the simulated or actual environment UI.

In some aspects, the techniques described herein relate to a computer-implemented method of simulating user interaction with control interfaces, including: displaying, on a display, a simulated environment user interface (UI) to a user, wherein the simulated environment UI represents a test UI of a vehicle; receiving, from one or more sensors, signals indicative of a first user interaction with the displayed simulated environment UI; calculating a plurality of parameters of the simulated environment UI based on the received signals indicative of the first user interaction, wherein the plurality of parameters includes: one or more of: a total eyes off UI time metric, a task completion time, a subtask completion time, or a performance score; and outputting an indication for the actual user interface.

### BRIEF DESCRIPTION OF THE DRAWINGS

The foregoing is a summary, and thus, necessarily limited in detail. The above-mentioned aspects, as well as other aspects, features, and advantages of the present technology are described below in connection with various embodiments, with reference made to the accompanying drawings.

FIG. 1 shows a schematic of a system for analyzing and testing human machine interfaces.

FIG. 2 shows one embodiment of a simulated environment for analyzing and testing human machine interfaces.

FIG. 3 shows another embodiment of a simulated environment for analyzing and testing human machine interfaces.

FIG. 4 shows another embodiment of a simulated environment for analyzing and testing human machine interfaces.

FIG. 5A shows a side view of one embodiment of an actual environment, installed in a vehicle, for analyzing and testing human machine interfaces.

FIG. 5B shows a top view of one embodiment of an actual environment, installed in a vehicle, for analyzing and testing human machine interfaces.

FIG. 6 shows another embodiment of an actual environment for analyzing and testing human machine interfaces.

FIG. 7 shows exemplary tasks and subtasks for completion on a human machine interface.

FIG. 8 shows a computer-implemented method of evaluating a human machine interface in an actual environment.

FIG. 9 shows a computer-implemented method of comparing interaction with a human machine interface in simulated and actual environments.

FIG. 10 shows a computer-implemented method of evaluating a human machine interface in a simulated environment.

The illustrated embodiments are merely examples and are not intended to limit the disclosure. The schematics are drawn to illustrate features and concepts and are not necessarily drawn to scale.

### DETAILED DESCRIPTION

The foregoing is a summary, and thus, necessarily limited in detail. The above-mentioned aspects, as well as other aspects, features, and advantages of the present technology will now be described in connection with various embodiments. The inclusion of the following embodiments is not intended to limit the disclosure to these embodiments, but rather to enable any person skilled in the art to make and use the contemplated invention(s). Other embodiments may be utilized, and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

In general, the systems and methods described herein provide a systematic, repeatable, quantitative way to measure user interaction to understand the performance of complex systems with the user as a component and how the user, the system, and the interaction of the two is affecting overall performance. This system can be used by product teams to improve their products performance and safety, and the processing of data using the software, provides annotated data that can then be further processed into algorithms and/or fed into artificial intelligence systems.

As used herein, human machine interface (HMI), user interface (UI), a graphical user interface (GIU) may be used interchangeably in that the various systems, methods, and devices described herein may be applied to analyze HMI, UI, and GUI.

In general, a user of an HMI/UI may include a technician, design engineer, user interface designer, user experience designer, a front-end developer, visual designer, quality control engineer, interaction designer, user researcher, product designer, a general population person, etc. Identifying information of the user may be hidden or de-identified in any of the sensor data collected.

In general, the systems described herein are configured to capture user interaction data, including touch, voice, movement, visual attention, and facial expression, paired with system and environment or contextual data. In some embodiments, user interaction data comprising movement data may also include measuring multitasking activities of the user, for example phone use. These data are then ported to an analysis software for replay, analysis, annotation, and processing to be used in supporting engineering, testing, and/or safety analytics. Such data may be prepared for post-processing to build machine learning models for autonomy, application specific integrated circuits, and software.

In general, the systems and methods described herein may be used with any system that employs HMIs/UIs. Exemplary, non-limiting examples of such systems include: command and control systems, battle management systems, ground station systems, Supervisory Control and Data Acquisition (SCADA) systems, industrial systems, manned or unmanned spacecraft systems, airplane systems, radar systems, sonar systems, air traffic control systems, car systems, Vertical Takeoff and Landing (VTOL) aircraft systems, tank systems, armored vehicle systems, remotely operated submersible systems, remotely operated rover systems for space exploration and bomb disposal (EOD), all manner of HMI on ship and submarine systems, missile warning and defense ground station systems, orbit servicing and assembly ground stations systems and control room systems, multi-user operations with unmanned systems, multi-user operations with combinations of vehicles and command and control in complex operations systems, agricultural vehicle systems, mining vehicle systems, etc. Additionally, or alternatively, the systems and methods described herein may be used in modeling, analyzing, and/or testing of cyber security operations, either with a single operator, in a cyber security operations center (SOC), or networked across multiple users or SOCs in different locations.

Further, since some of the human machine interfaces (HMIs) that may be tested may be pre-market and/or test HMIs, any of the user interfaces (UIs) or HMI described herein may be configured such that they prevent imaging of the UI or HMI by the user or at least record when a user has taken images or recordings of the UI or HMI. Further for example, there might be an obscure or imperceptible phrase or time stamp that will show up in any pictures taken of the interface. Still further, for example, there may be imperceptible variations of each UI so that if a user ‘leaks’ a design, it may be determined who was the source of the leak.

As identified above, the problem with commercially available systems is their complex installation, security, expense, mobility, and predictive capacity. The technical solution to such technical problems is to provide data-driven devices and/or software to assist in automotive design, in particular UI and HMI design. This disclosure describes data collection devices and methods, data analysis and practical applications of the data analysis, and a machine learning approach.

Data collection in the systems described herein is accomplished through in-vehicle sensors recording the user interactions with an actual vehicle or a user interface of the vehicle (actual environment), and in-home device sensors recording the user interactions with a simulated vehicle or a user interface of the vehicle (simulated environment).

The simulated environments and actual environments described herein are configured to create situations in which the user should behave substantially consistent (e.g., using the same methods to perform a task or subtask). For example, the systems described herein may be configured such that paired data may be measured and/or collected from an individual driving an actual vehicle and using the interface of that vehicle and the same individual in-home, performing a driving proxy task in the same way while using the recorded interface of that vehicle. Ideally, paired data will be collected over time for each individual in a variety of vehicles and a variety of driving contexts over time in either or both simulated and actual environments. Additionally, or alternatively, there may be data pairing between a UI design and an updated UI design (e.g., based on software revisions). The data collected by the sensors may represent user interaction with the UI design and then user interaction with the updated UI design, the user interaction with the UI design and the updated UI design being paired. Additionally, or alternatively, there may be data pairing between vehicle UI. In such embodiments, the processor may be configured to analyze user interaction between two or more analysis periods and separate user interaction with vehicle characteristics from user interaction with vehicle UI.

In general, the data, from one or more sensors, received by the system may be separated into one or more datasets, collectively stored in a database. For example, a dataset may comprise: visual data (e.g., video) of user interface components; metadata of user interface components (e.g., alphanumeric codes for interface elements, relative timing, and information about goal state, including success of the task); visual data (e.g., video) of user interactions; metadata of user interactions (e.g., alphanumeric codes for actions, relative timing, and information about goal state, including success of the task); visual data (e.g., video) of contextual (e.g., environmental); metadata of contextual (e.g., environmental) information. For example, alphanumeric codes paired to various UI elements may be in a look up table. In some instances, video data and associated sensor data may be captured first, encrypted, then moved to another system (e.g., manual or automated system) to structure and create accompanying metadata. These metadata may be used, in conjunction with video, to create semi-autonomous or fully autonomous data structuring approaches. Video data and metadata may be stored separately, associated through alphanumeric codes, the key to which may be stored separately.

In some instances of the present invention, the sensor data, video, and structured metadata may be fed into one or more machine learning models and/or algorithmic models configured to output one or more parameters or states of the user, for example, a posture state, a fatigue state, a visual attentional parameter, an auditory attentional parameter, or a tactile attentional parameter, for example in terms of both the moment and longitudinal temporal characteristics of each. In some instances of the present invention, the sensor data, video, and/or structured metadata may be fed into one or more machine learning models and/or algorithmic models configured to output one or more states of the UI and/or of the context (e.g., objects exterior to the vehicle, activity surrounding the vehicle, etc.). Various combinations of user parameters, user statistics, UI states, and context states may be combined to produce training data for machine learning models associating human and environmental characteristics with design, bidirectionally.

In some embodiments, as the database increases in size, the system may be configured to leverage generative machine learning capabilities to provide extrapolations to outcomes not within the database. For example, the device might modify both the video and metadata of an event to show how an aged user would be expected to respond on-road, in the absence of actual video or metadata recorded of that specific scenario. In such a scenario, the device would tag that combination predicted for future data collection, and upon receiving the data, would use it both to update the prediction and to enhance the prediction machine learning system. Further, by analyzing all extrapolations, the system may be configured to identify which types of data are needed and/or when they are needed.

In some embodiments, specific events, metadata, etc. may be tagged for further analysis. For example, if a driver almost hit another car, the event may be tagged or the sequence of events leading up to the near miss may be tagged, so that annotation could be added describing the experience of the user at that moment. These events could be tagged in the data either by use of a button, a voice command, or other method.

In some embodiments, the output from the system and/or one or more machine learning models is one or more of a candidate design or proposed design or updated design for a UI. In some embodiments, the output is a prediction of an outcome of a user interaction with the UI, for example in different vehicles, different contexts, and/or in different populations of users. The system may be further configured to test permutations of the one or more candidate or proposed designs and determine which permutation(s) lead to more desirable outcomes, as designed by the user. For example, this functionality could be used to evaluate a proposed new automotive interface, evaluate a software update to an existing automotive interface, or evaluate candidate automotive interfaces as compared to one another. The system may be configured to evaluate the impact of singular changes and/or aggregate changes. Said another way, statistical generalizations can be created that may generally hold true across a population of people, across vehicles from a particular manufacturer, etc.

In general, any of the systems described herein may be configured to determine relationships between video and metadata of in vehicle events and/or predict expected outcomes. From a vehicle sales perspective, in some embodiments, a display may be configured to show a possible vehicle purchaser a variety of interfaces similar to the one the possible vehicle purchaser is considering. When linked to a design tool, through a computer aided design package, the system may be configured to associate a UI being designed with pre-existing UI and provide screenshots and video footage of users in the database accessing the UI in actual environments across a variety of contextual situations and user populations.

In general, any of the systems, devices, methods, and/or data described herein may be secured via one or more methods. For example, homomorphic encryption or state-of-the-art cryptology methods may be used to securely transmit and analyze data. In situations necessitating heightened security, such as evaluation of unreleased components or UI, the original video data and associated sensor data can be moved off-line or even deleted.

In some instances, data may be auto formatted into a format more easily processed or that can be consumed by end-users/customers. The data may also be time-locked so that vehicle manufacturers can provide vehicle system data at a later date, or in parallel, via the access method most appropriate to the vehicle technology.

Taken together, the disclosure describes an ecosystem of data collection, structuring these data in an increasingly automated fashion, and providing state predictions. Data collection in-vehicle (actual environment) and in-home (simulated environment) is used to produce a pipeline of data correlated across dimensions of interest which feeds a system which can provide useful predictions to assist in automotive design, and in the prediction of the impact of automotive design. The system is a feedback cycle, extrapolating to situations not yet within its collected data, and filling in those blanks proactively after such an extrapolation. Although “in-home” is used, one of skill in the art will appreciate that a simulated environment may be set up in an office, home, workspace, school, etc.

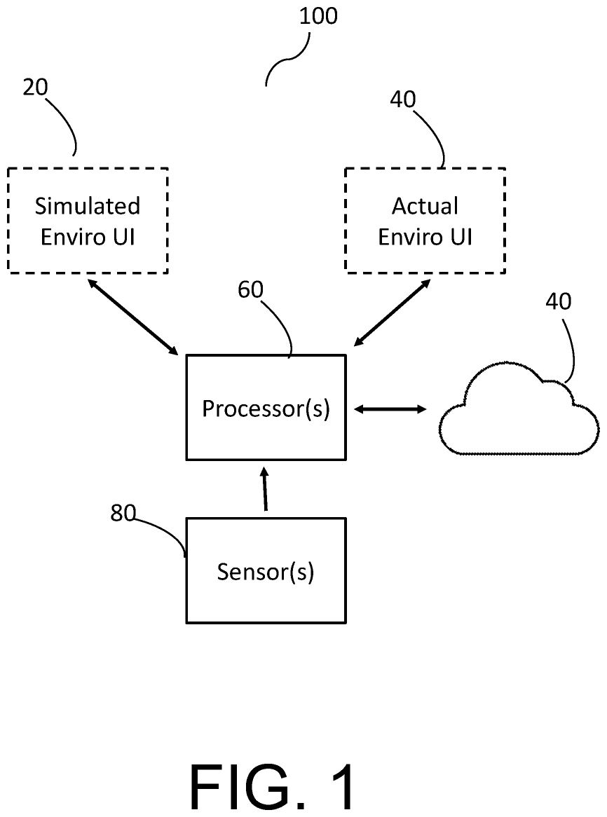

FIG. 1 shows a schematic of a system 100 for analyzing and testing a UI or HMI. A system 100 may optionally (shown in dashed lines) include a simulated environment user interface (UI) 20 and/or an actual environment UI 40. Sensed user interactions, via one or more sensors 80, with either or both UIs may be processed by a processor(s) 60 coupled to memory and a computer readable medium having instructions stored thereon for execution by the processor. In some embodiments, the computer readable medium and memory coupled to the processor may be local (e.g., in the vehicle) such that it may capture the data from the sensors (e.g., cameras, eye tracking sensors, etc.). In some embodiments, as shown in FIG. 1, the data stored on the local computer readable medium and memory may be wirelessly transmitted to a remote server 90 (e.g., Cloud) in real-time or on demand during data acquisition or after data acquisition is complete. Alternatively, the data may be wirelessly transmitted to a remote server 90 without any local storage.

The sensors 80 employed in the system may be any one or more of: image sensors (e.g., cameras), motion sensors, infrared sensors, LiDAR (light detection and ranging), force sensors, pressure sensors, physiological sensors (e.g., electrodermal sensors, electroencephalography sensors, electromyography sensors), etc. In some embodiments, one or more sensors 80 may be integrated into a wearable worn by the user or in proximity to the user, for example eye tracking glasses, watches, sensorized mats or cushions for on seats, etc. The sensors may be configured to capture user interaction with the actual or simulated UI, the user interaction comprising one or more of: touch, gaze, voice, bodily movement, and posture.

In some embodiments, sensor data from multiple sensors 80 (e.g., images or video from multiple cameras) may be stitched together, for example into a video. The video may be three-dimensional, for example to enable scanning through a scene, annotation of a scene, and/or for analyzing a scene for safety, usability, and sentinel scenarios. As used herein, sentinel scenarios are used to describe scenarios in which analysis is needed to determine the user interactions, contexts, etc. that resulted in a user interaction (e.g., in the vehicle, in a context, with the HMI) being determined to be positive, negative, or unpredicted. Various features, for example the HMI or other contextual features, may be overlaid onto the three-dimensional video. Sensor data, for example from an OBD2 port or CANBUS may also be overlaid and/or used to provide contextual data (e.g., vehicle state information).

In some embodiments, triangulation of gaze or view pinpoint may be performed using a plurality of sensors 80 coupled to a processor 60, such that the triangulation calculation performed by the processor 60 may be compared to or may be used to augment similar calculations from eye tracking glasses or another wearable. The calculations may be used to increase the precision in measuring where and when users are looking.

In some embodiments, the sensor data may be used to create cones of sight and/or visual heat maps to be used for analyzing user interactions in simulated or actual environments, vehicle contextual data, etc. In some embodiments, the cone or visual representation of the visual field of view may be segmented to show where it is in relation to the user's peripheral vision.

The processor 60 may be further configured to determine and/or cause a display to display a point in time when an interaction was initiated or completed, to adjust the pinpoint marking (i.e., an indication of what the system determines the user is looking at) or heatmap highlighting created by the eye tracking glasses, to adjust what/where the person was looking (e.g., adjust based on context, UI specific features, etc.), etc. Such processor 60 functions may also be described as annotating. In other embodiments, such annotating may be performed manually by a user. Annotation of data acquired using the systems and methods described herein may be linked (e.g., based on reference tables, look-up tables, labeling, etc.) to other engineering documents and software and/or fed into machine learning algorithms for additional post-processing.

Further, as shown in FIG. 1, a simulated user interface 20 may be displayed on any one or more of: a ground station, a mobile computing device (e.g., laptop, netbook, tablet, etc.), a desktop computer, or the like. An actual user interface 40 may be displayed in any type of craft, vehicle, boat, command center, control center, etc., as indicated elsewhere herein. In some embodiments, the simulated and/or actual environment systems may also be used to present “clickable” UI wireframe designs to be displayed to a user. In still further embodiments, a simulated UI may be displayed on an actual environment HMI to test the simulated UI in an actual environment. Further, a GUI may be updated on an HMI to test or analyze the GUI updates prior to an actual update event.

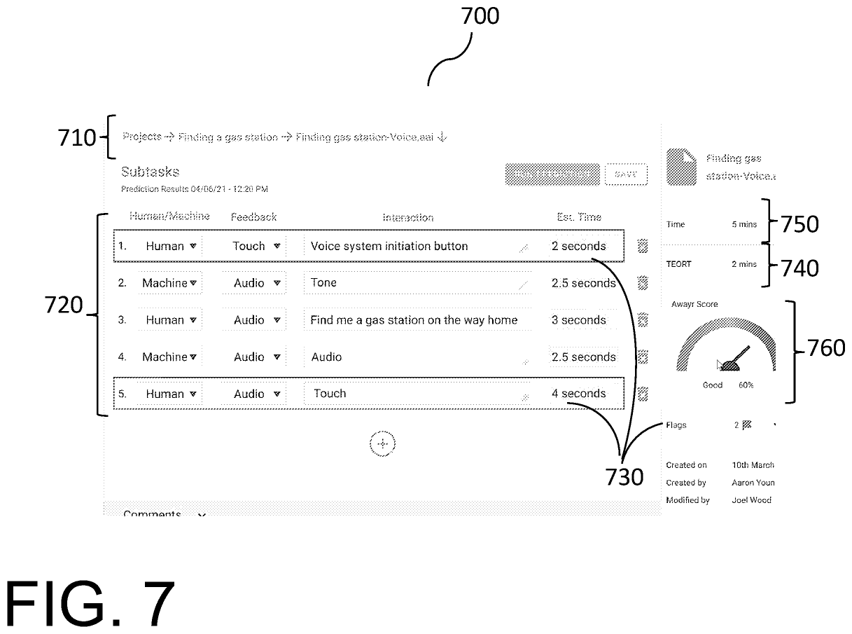

Turning now to FIG. 7, which shows on example of a reporting display 700 of an analysis of a user interaction with a user interface. A task 710 a user is to perform may be divided into subtasks 720, such that various parameters of the user interaction may be analyzed and reported for each subtask 720 and for the task 710 as a whole. Such task and subtask creation and analysis may be based, at least in part, on the antiphony framework (Sawyer, B D, et al. “Toward an Antiphony Framework for Dividing Tasks into Subtasks,” PROCEEDINGS of the Ninth International Driving Symposium on Human Factors in Driver Assessment, Training and Vehicle Design, Jul. 27, 2017, the contents of which is herein incorporated by reference in its entirety). Subtasks720 that are analyzed and flagged 730 (e.g., by highlighting; boxing; changing color, font, size, etc.) by the processor as not meeting a threshold or exceeding a threshold may be indicated on the reporting display 700, such as the one shown in FIG. 7. For example, if the subtask completion time exceeded a predetermined threshold, the subtask may be flagged 730. Further, for example, if the Total Eyes Off Road Time (TOERT) 740 or task completion time 750 exceeded a predetermined threshold for a task, subtasks 720 predicted by the processor as contributing to the exceeded TOERT threshold may be flagged 730 by the system.

In some embodiments, a processor may be further configured to calculate a performance score 760 for the UI, such score being displayable on the reporting display 700. For example, an onboard processor or remote processor (e.g., server, workstation, mobile device, etc.) is configured to calculate the performance score. Generally, a performance score indicates a quality, safety, and/or usability score for the task or the subtask as a whole on the HMI/UI/GUI. More specifically, the score may represent the relative probability of different UIs producing failing marks relative to an aggregate index of governmental safety guidelines for UIs. For example, in automotive manufacturer testing a new software update could receive a before and after the update score, relative to the safety guidelines they were required to conform to within one or more regions in which the UI would be deployed. Likewise, the score may be used to represent the comparative risk of vehicle models or of sub variance of vehicle models. It may, therefore in some embodiments, be used in the calculation of actuarial values for determining risk (e.g., insurance calculations) or to assist in the decisions made by users as to the relative risk/reward ratio of various vehicle models. As such, the performance score may become a widely recognized score, similar to physical safety scores such as crash test scores, accident-avoidance scores, rollover resistance, roof strength, rear impact protection, etc.

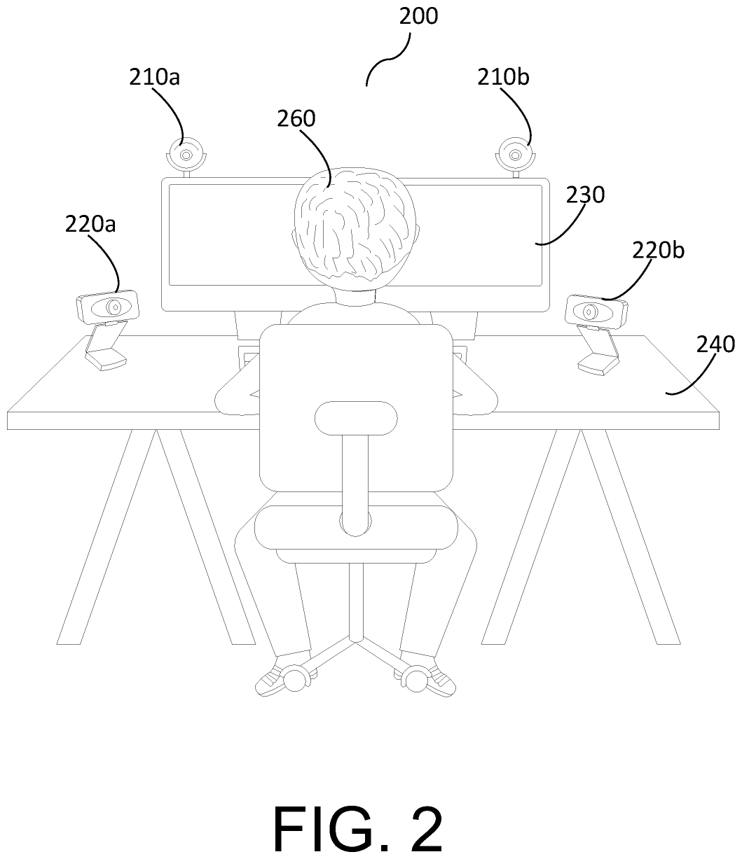

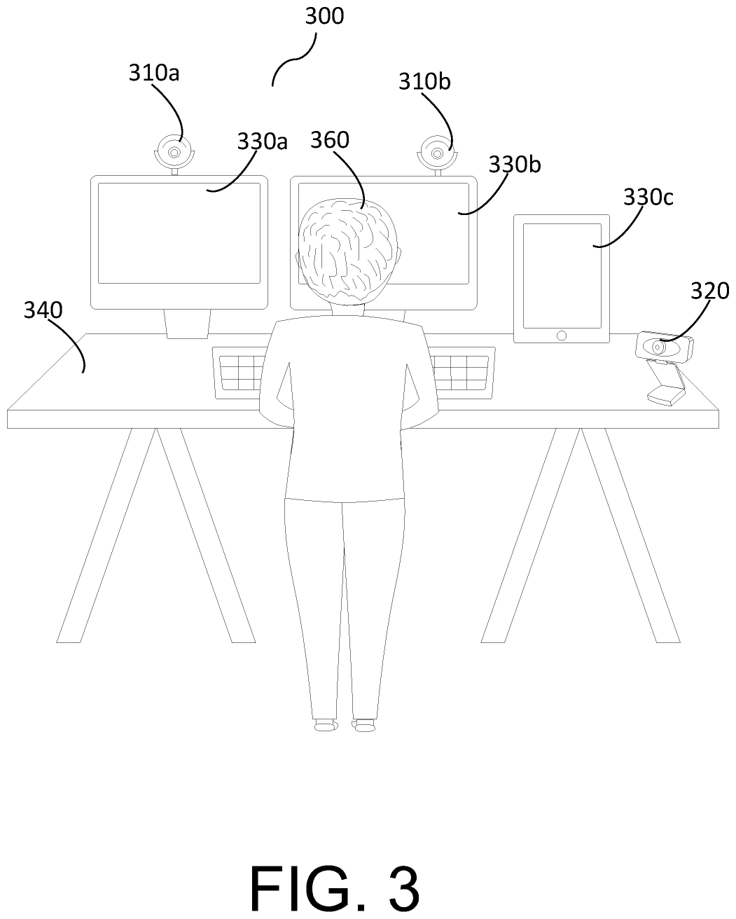

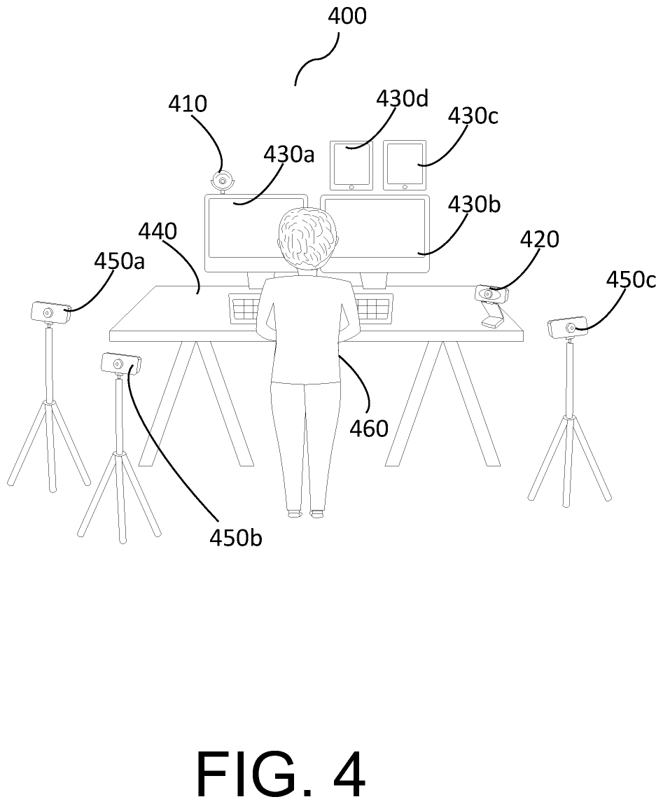

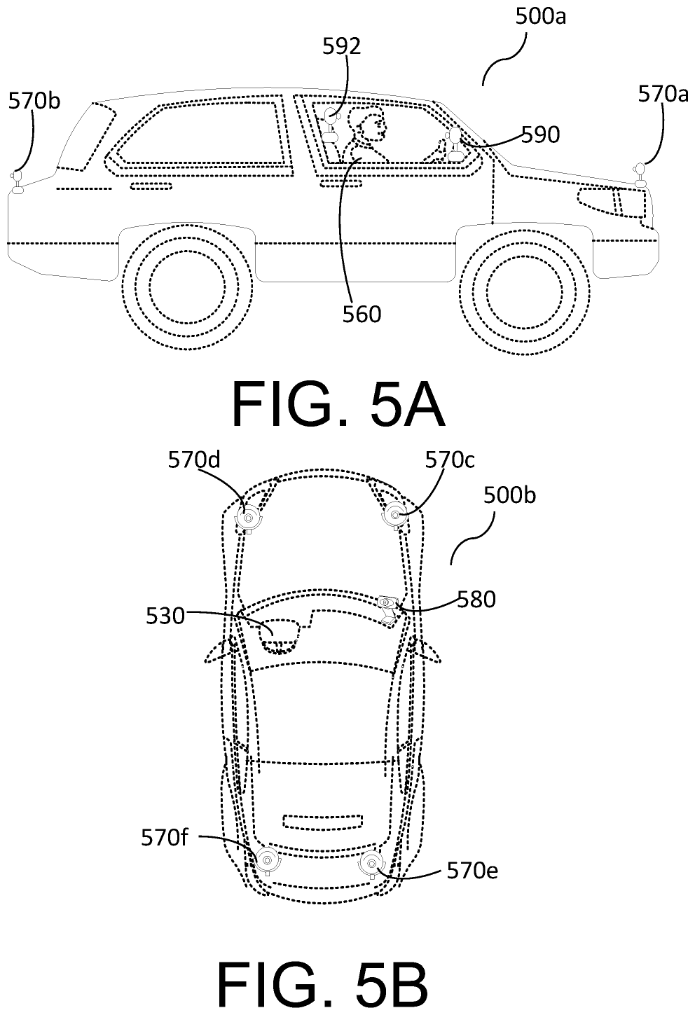

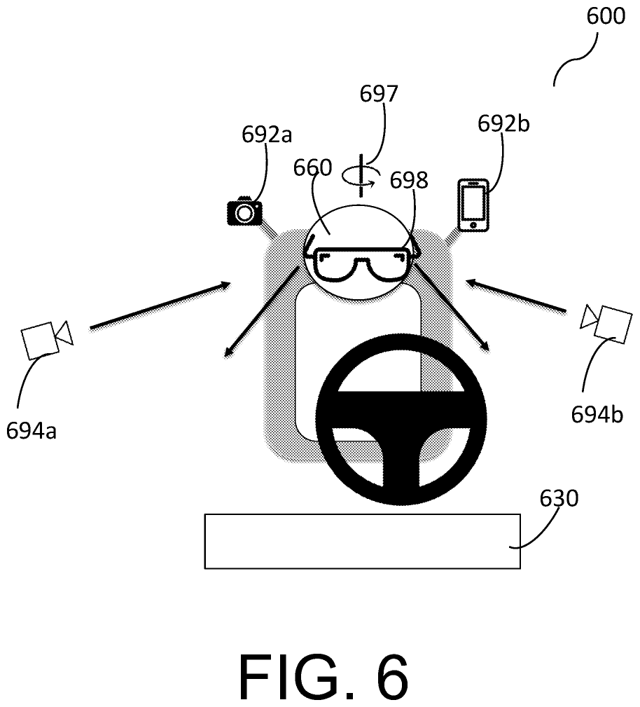

Turning now to FIGS. 2-6, which show simulated environment systems (FIGS. 2-4) and actual environment systems (FIGS. 5A-6). As is discernible from the figures, similar systems may be used in either setting. For example, a simulated environment system may be used in an actual environment and an actual environment system may be used in a simulated environment. As such, although systems may be described with respect to a particular environment, it shall be understood that the system can be used in either environment.

As shown in FIGS. 2-4, a simulated environment 200, 300, 400 may include one or more displays 230, 330a, 330b, 330c, 430a, 430b, 430c, 430d configured to display a UI, and one or more sensors 210, 310, 410, 220, 320, 420, 450. The sensors 210a, 210b, 310a, 310b may be mounted to a display 230, 330a, 330b, 330c, 430a, 430b, 430c, 430d. The sensors 220a, 220b, 320, 420 may be mounted to a surface 240, 340, 440, for example a work surface, desk, station, etc. The sensors 450a, 450b, 450c may also be free-standing (e.g., including tripod, legs, or other structure or stand).

In embodiments comprising one display, there may be multiple windows displayed on the display. In embodiments comprising multiple displays, each display may display a unique window. For example, a first window or display may display a distracting task (e.g., touching a periodically moving ball) and a second window or display may display a task for completion on a simulated vehicle UI. The sensors substantially surrounding the user may then be configured to capture user interaction with the UI as he/she completes the task. Any number of tablets, monitors, screens, etc. can be used and re-arranged to simulate different types of vehicle interfaces.

In some embodiments of FIGS. 2-4, a simulated environment may further include one or more control devices configured to replicate controls found in vehicles, including, but not limited to, steering wheels, pedals, and buttons.

Once the simulated environment system is received, a user may begin by downloading an application onto a computing device of the user, which guides the user through setting up the system in an appropriate location and orientation, and connecting and setting up the locations and orientations of any accompanying sensors or control devices. The user is then trained through modules to use the UI while also engaging in a driving proxy task. The UI may display actual center stack material captured in-vehicle by in-vehicle device recordings, as well as prototype UIs designed in the absence of deployment in an actual vehicle. The driving proxy task may include, but not be limited to, various motor control tasks to be performed on the display or through control devices accompanying the system. These include first-person driving games, overhead driving games, and simple tracking tasks in which the user adjusts the motion of a digital object relative to another. Upon the completion of the simulated, e.g., complete a drive while using the UI, the application may guide the user through qualitative questions relative to his/her experience.

Similar onboarding and/or training, as described elsewhere herein, may also be used for mock stations, for example ground stations.

As shown in FIGS. 5A-6, an actual environment 500a, 500b, 600 may include one or more displays 530, 630 configured to display a UI, and one or more sensors 570a, 570b, 570c, 570d, 570e, 580, 590, 592, 592a, 592b, 694a, 694b, 696. The sensors may be externally mounted on the vehicle, for example on a rear portion (see, e.g., sensors 570b, 570e, 570f or a front portion (see, e.g., sensors 570a, 570c, 570d); on a dashboard (see, e.g., sensor 590); on a windshield internally or externally (see, e.g., sensor 580); on a seat back (see, e.g., sensors 592; 692a, 692b); on a wearable (see, e.g., sensor 696); or at another location in the vehicle, as represented by sensors 694a, 694b. Arrow 697 indicates that the system is configured to triangulate a position and/or orientation of a head of a user, for example to calibrate one or more sensors and/or determine what a user is seeing and/or their field of vision.

Optionally, eye tracking sensors may also be installed in the dash as a ‘hard install’ to the vehicle, while still electrically connected to a local power source and/or local computer readable medium and memory for data storage. One or more sensors may also be positioned on an under carriage of the vehicle, in a wheel well of the vehicle, or otherwise mounted on the vehicle such that the sensors can detect road conditions, for example road type (e.g., gravel, pavement, etc.), slope, grade, condition, moisture, etc.

The one or more sensors positioned within the vehicle and/or on the exterior of the vehicle may be configured to capture additional data (e.g., images, video, sensor data, etc.) indicating a status of the driver and/or contextual data of the driving conditions and environment.

Additionally, or alternatively, one or more sensors may be permanently installed (as opposed to temporary installation as described above) such that data can be collected over time and installation is not repeated.

In embodiments where multiple vehicles in an environment are outfitted with one or more of the systems described herein, interactions between the drivers and/or vehicles on the road, including vehicle to vehicle communication interactions, can be recorded and synchronized.

In either or both actual and simulated environments, the sensors are configured to be positioned to substantially surround a user 260, 360, 460, 560, 660. For example, the sensors may provide an “over-the-shoulder” view, side view, front view, rear review, oblique view, etc. of the user 260, 360, 460, 560, 660 or a UI that the user is interacting with. The user may also be optionally wearing one or more sensors, for example via a wearable system (e.g., eye tracking glasses with sensor 698, watch, etc.). The sensors may be powered by an internal batter or external power source. Data may be recorded to an internal storage medium of the sensor or on external hard drive. Data may be transmitted to a hard drive either wirelessly or via wire.

The sensors 210, 220, 310, 320, 410, 420, 450, 570, 580, 590, 592, 692, 694 may be mountable using telescoping legs, a temporary adhesive, a windshield mount, a rubber (anti-slip) strip, pressure sensitive adhesive, etc.

In some embodiments, user interaction data with the UI is compared and/or correlated to or with contextual data or vehicle sensor data collected by the sensors coupled to the vehicle, which may be correlated in time and/or context.

One or more sensors may be at least partially encased in a housing. The housing may further encase a power source, local storage, local processor, antenna, etc. for functioning of the sensor. Heavy or extensive processing of sensor data may be performed by a second processor remote from the local processor, for example at a server, in vehicle, or other computing device.

In some embodiments, once the sensors are installed and activated (in simulated or actual environment), a user may be directed (e.g., via audio or visual instructions) to download an application to a computing device of the user. Once the application is installed, a communications link to the sensor (e.g., in the same housing) is established wirelessly (e.g., via an antenna) or by cable (e.g., via a databus), and the user is guided through the installation of the sensor in the simulated or actual environment. Once the sensor is secured in the actual or simulated environment, the user may be instructed to orient each sensor, for example to capture a central, side, rear, interior, exterior, etc. view. These cameras provide the ability to record all or a subset of the sides of the simulated or actual environment and provide coverage of at least a portion of the body of the user and the UI. Once the orientation has been achieved, the user is guided through activating the display or UI and moving through various screens of the UI. In some embodiments, the activation process may be recorded by one or more sensors to generate an image of the UI installed in the vehicle, including the current software version. In some embodiments, the user may be further instructed to update or rollback software versions. Finally, in some embodiments, the user may enter a training module to teach the user how to use the system in a simulated environment or in an on-road or actual environment (e.g., while driving the vehicle in which the system is installed).

For actual environments, one or more sensors may be affixed to movable vehicle components, pressure-sensitive vehicle components, etc. For example, an accelerometer for attachment to movable vehicle components (e.g., pedals, wheel, lever) may be wireless (e.g., Bluetooth, near-field communication, etc.) enabled and comprise an attachment mechanism (e.g., rubber strip on one side and adhesive on the opposing side). Further for example, a pressure sensor for attachment to pressure-sensitive vehicle components (e.g., buttons, touchscreens, touchpads, and sliders) may also be wireless ((e.g., Bluetooth, near-field communication, etc.) enabled and comprise an attachment mechanism (e.g., sticker, adhesive, etc.).

Once set up, for example as shown in FIGS. 5A-6, the system is configured to guide the user through using the UI while driving on a road. The system uses its external environment cameras to correlate exterior environmental conditions to delivery of in vehicle instructions to the driver to use a specific user interface element. This is enhanced by the application on the user's computing device, which uses, for example, GPS to track a location of the computing device and thus the user and the vehicle. As such, the system is configured to guide the user to specific locations and/or to trigger the use of the user interface in specific situations of interest. For example, if the test protocol requires a driver to use the music system while stopped at a red light, the exterior cameras will observe the environment and look for a suitable junction. When prompted to take a task, users have the option to override the system if it is not an appropriate or safe time to perform the task. Upon the completion of a drive, when the driver is safely off the roadway, the user may be guided through the application on the computing device to qualitatively assess their experience. An additional capability of the actual environment system is to allow UI captured in one vehicle to be transmitted and/or displayed in another vehicle during vehicle operation. In this situation, the system may be used to capture UI on vehicle A, which will then be played back on vehicle B, and then vice versa. In this situation, the UI and vehicle characteristics from the two vehicles become separable, as described elsewhere herein.

To synchronize systems within a vehicle or across vehicles or between a vehicle and infrastructure or in swarms of vehicles or between a simulated and actual environment, the hardware (e.g., sensors, communicatively coupled computing device, display, etc.) may include a ‘start’ and ‘stop’ button that starts or stops all or a subset of the sensors (e.g., camera(s), eye tracking device(s)) in unison or in a sequence. Additionally, or alternatively, an infrared strobe light may be mounted within view of all or a subset of the sensors, such that the infrared strobe light may be used to synchronize sensor data in a vehicle or sensor data across a plurality of vehicles or sensor data between an actual and simulated environment. The same approach (infrared strobe light) may also be used to synchronize sensor data across geographic locations, for example when networked operator interactions for complex command and control actions are in different geographic locations but need to execute tasks as a team. In some embodiments, atomic clocks, the internet, or other referencing or synchronizing technologies known in the art may also be used. For example, the start of the sensor readings may be synchronized using atomic clocks, or the internet, and then the strobes in both locations can help to maintain synchronization between the two sets of data, over long-time intervals, where there is the risk of signals becoming unsynchronized.

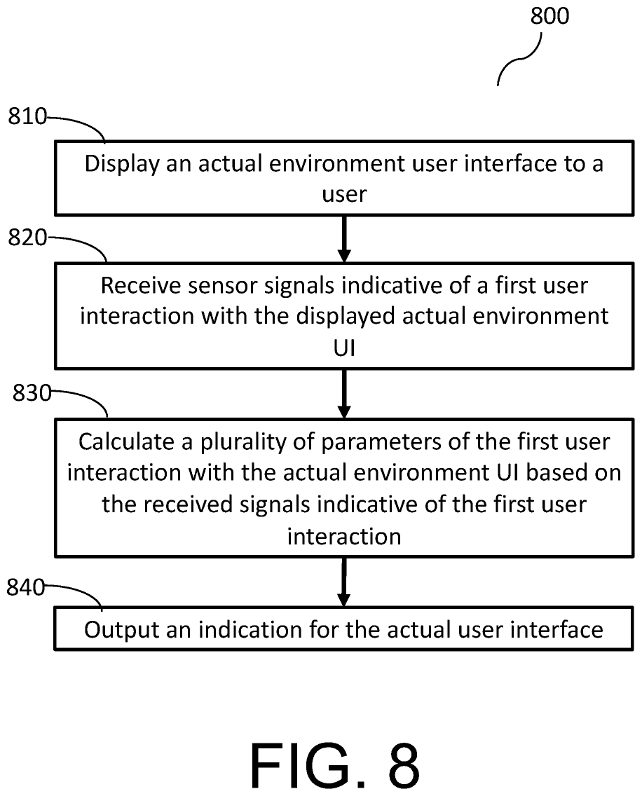

In some embodiments, a computer-implemented method of evaluating a control interface based on user interaction comprises various steps as shown in FIGS. 8-10. In some embodiments, a computer readable medium comprises processor executable instructions thereon, such that the instructions comprise the steps as shown in FIGS. 8-10. In some embodiments, a system comprising a processor coupled to a computer readable medium and memory is configured such that the processor executes the steps as shown in FIGS. 8-10.

Turning to FIG. 8, a method 800 of evaluating a control interface includes: displaying, on any of the displays described herein, an actual environment user interface (UI) to a user at block 810; receiving, from any of the sensors described herein, signals indicative of a first user interaction with the displayed actual environment UI at block 820; calculating a plurality of parameters of the first user interaction with the actual environment UI based on the received signals indicative of the first user interaction at block 830; and outputting an indication for the actual user interface at block 840.

The plurality of parameters may comprise, but not be limited to, one or more of: a total eyes off road time metric, a task completion time, a subtask completion time, or a performance score.

In some embodiments, the actual environment UI is a test UI of a vehicle but could alternatively, or additionally, be a test UI for any type of craft, vehicle, plane, control system, command system, etc.

In some embodiments, the indication comprises a performance indication of a feature of the actual environment UI. In other instances, the indication comprises a recommendation. The recommendations may include, but not be limited to: a UI feature replacement, a UI feature elimination, a subtask modification, or a combination thereof.

The method 800 may optionally include outputting guidance to the user to position the one or more sensors so that the one or more sensors are configured to capture the first user interaction with the displayed actual environment UI.

The method 800 may optionally further include triangulating, using the sensor signals, an eye position of the user; and determining the first user interaction based on the triangulation, wherein the first user interaction is a visual interaction.

The method 800 may optionally include capturing a light interval, with the plurality of cameras, from a periodic light source; and synchronizing, in time, the plurality of cameras based on the captured light interval.

In some embodiments, the displayed actual environment UI comprises a task UI, such the method comprises displaying a task for completion on the task UI. The task may optionally be broken into subtasks that are either predetermined or use selected, for example during the user interaction.

The method 800 may optionally further include receiving a user input of a make and model of the vehicle that is associated with the test UI; and updating the indication based on the user input.

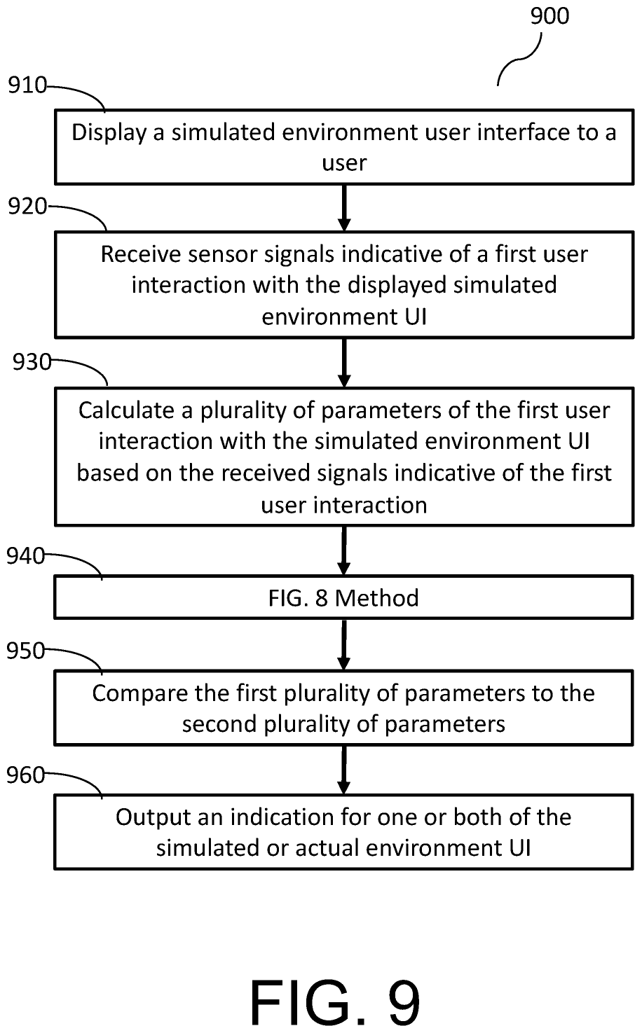

Turning to FIG. 9, a method 900 of evaluating control interfaces based on user interactions in simulated and actual environments, includes: displaying, on any of the displays described herein, a simulated environment user interface (UI) to a user at block 910; receiving, from any of the sensors described herein, signals indicative of a first user interaction with the displayed simulated environment UI at block 920; calculating a plurality of parameters of the simulated environment UI based on the received signals indicative of the first user interaction at block 930; performing the method of FIG. 8 at block 940; comparing the first plurality of parameters to the second plurality of parameters at block 950; and outputting an indication for one or both of the simulated or actual environment UI at block 960.

The plurality of parameters may comprise, but not be limited to, one or more of: a total eyes off road time metric, a task completion time, a subtask completion time, or a performance score.

In some embodiments, the actual environment UI is a test UI of a vehicle but could alternatively, or additionally, be a test UI for any type of craft, vehicle, plane, control system, command system, etc.

In the method 900 of FIG. 9, the displayed actual environment UI corresponds to the displayed simulated environment UI, the actual UI being a test UI, as described elsewhere herein.

Method 900 may optionally further include calculating a plurality of user parameters for the user of the actual environment UI. The plurality of user parameters may include, but not be limited to: a posture, a fatigue, a visual interaction pattern, an auditory interaction pattern, a tactile interaction pattern, or a combination thereof.

Method 900 may optionally further include calculating a readiness of the user for interaction with the actual environment UI based on the calculated plurality of parameters. Any one or more of the displays may present an updated actual environment UI when the readiness of the user exceeds a predetermined threshold. The indication may include a user interface quality indicator of the displayed actual environment UI based on the second user interaction with the displayed actual environment UI.

In some embodiments, the first or the second user interaction comprises one or more of: a user touch, a user look, a user voice, a user bodily movement (arm movement, shoulder movement, etc.), or a user posture.

Method 900 may optionally further include calculating a relative probability that one or both of the displayed simulated environment UI or the actual environment UI meet or exceed a predefined safety threshold.

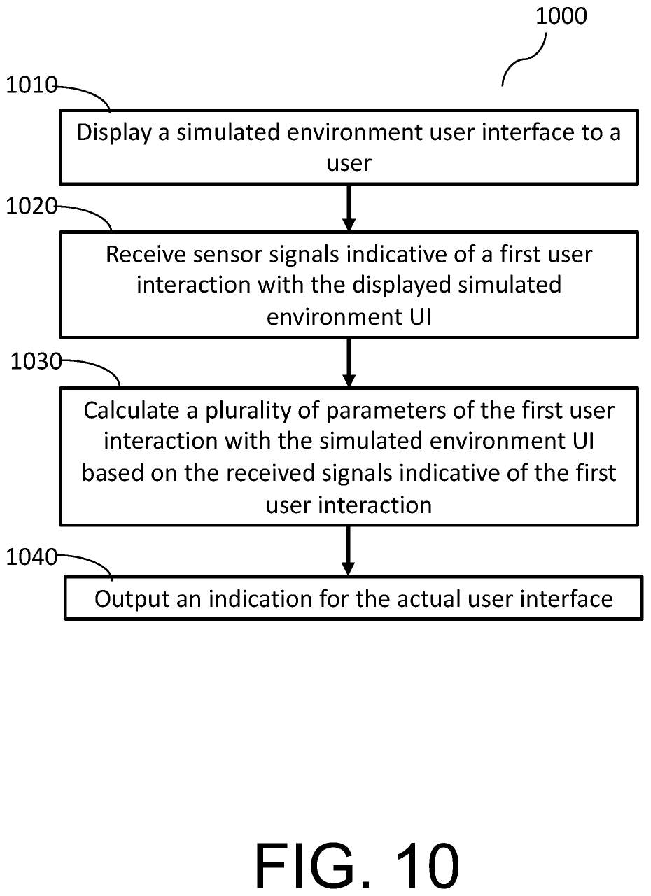

Turning to FIG. 10, a method 1000 of simulating user interaction with control interfaces includes: displaying, on any of the displays described herein, a simulated environment user interface (UI) to a user at block 1010; receiving, from any one or more of the sensors described herein, signals indicative of a first user interaction with the displayed simulated environment UI at block 1020; calculating a plurality of parameters of the simulated environment UI based on the received signals indicative of the first user interaction at block 1030; and outputting an indication for the actual user interface at block 1040.

The plurality of parameters may comprise, but not be limited to, one or more of: a total eyes off UI time metric (similar to a total eyes off road time metric), a task completion time, a subtask completion time, or a performance score.

In some embodiments, the actual environment UI is a test UI of a vehicle but could alternatively, or additionally, be a test UI for any type of craft, vehicle, plane, control system, command system, etc.

Method 1000 may optionally further include outputting a prediction of one or more metrics of an actual user interaction with an actual environment UI, that corresponds to the simulated environment UI, based on the calculated plurality of parameters.

Method 1000 may optionally further include calculating a second plurality of parameters for the user of the simulated environment UI. The second plurality of parameters may include, but not be limited to: a posture, a fatigue, a visual interaction pattern, an auditory interaction pattern, a tactile interaction pattern, or a combination thereof.

In some embodiments, the displayed simulated environment UI comprises a distraction UI and a task UI, such the method comprises displaying a task for completion on the task UI while displaying a distraction on the distraction UI. The distraction UI may be configured to display one or more of: simulated weather conditions, simulated road conditions, or simulated location conditions, although this list is non-limiting and may include any conditions (weather, traffic, or otherwise) that a user may encounter while driving.

Since the simulated environment doesn't necessarily include a road, the total eyes off UI metric is a total eye off task UI metric or a total eye on distraction UI metric.

Method 1000 may optionally further include receiving a user input of a make and model of the vehicle that is associated with the test UI; and updating the indication based on the user input.

The systems and methods of the preferred embodiment and variations thereof can be embodied and/or implemented at least in part as a machine configured to receive a computer-readable medium storing computer-readable instructions. The instructions are preferably executed by computer-executable components preferably integrated with the system and one or more portions of the processor in the vehicle, in the housing comprising one or more sensors, and/or computing device. The computer-readable medium can be stored on any suitable computer-readable media such as RAMs, ROMs, flash memory, EEPROMs, optical devices (e.g., CD or DVD), hard drives, floppy drives, or any suitable device. The computer-executable component is preferably a general or application-specific processor, but any suitable dedicated hardware or hardware/firmware combination can alternatively or additionally execute the instructions.

### Examples

Example 1. A computer-implemented method of evaluation a control interface based on user interaction, comprising: displaying, on a display, an actual environment user interface (UI) to a user, wherein the actual environment UI is a test UI of a vehicle; receiving, from one or more sensors, signals indicative of a first user interaction with the displayed actual environment UI; calculating a plurality of parameters of the first user interaction with the actual environment UI based on the received signals indicative of the first user interaction, wherein the plurality of parameters comprise one or more of: a total eyes off road time metric, a task completion time, a subtask completion time, or a performance score; and outputting an indication for the actual user interface.

Example 2. The computer-implemented method of any one of the preceding examples, but particularly Example 1, wherein the indication comprises a performance indication of a feature of the actual environment UI.

Example 3. The computer-implemented method of any one of the preceding examples, but particularly Example 1, wherein the indication comprises a recommendation.

Example 4. The computer-implemented method of any one of the preceding examples, but particularly Example 3, wherein the recommendation comprises a UI feature replacement, a UI feature elimination, a subtask modification, or a combination thereof.

Example 5. The computer-implemented method of any one of the preceding examples, but particularly Example 1, wherein the one or more sensors are integrated into one or more of: eye tracking glasses, microphone, a user-mountable camera, a seat-mountable camera, or a display-mountable camera.

Example 6. The computer-implemented method of any one of the preceding examples, but particularly Example 1, further comprising outputting a guidance to the user to position the one or more sensors so that the one or more sensors are configured to capture the first user interaction with the displayed actual environment UI.

Example 7. The computer-implemented method of any one of the preceding examples, but particularly Example 1, further comprising triangulating, using the signals, an eye position of the user; and determining the first user interaction based on the triangulation, wherein the first user interaction is a visual interaction.

Example 8. The computer-implemented method of any one of the preceding examples, but particularly Example 1, wherein the one or more sensors comprise a plurality of cameras, such that the method further comprises capturing a light interval, with the plurality of cameras, from a periodic light source; and synchronizing the plurality of cameras based on the captured light interval.

Example 9. The computer-implemented method of any one of the preceding examples, but particularly Example 1, wherein the displayed actual environment UI comprises a task UI, such the method comprises displaying a task for completion on the task UI.

Example 10. The computer-implemented method of any one of the preceding examples, but particularly Example 1, further comprising receiving a user input of a make and model of the vehicle that is associated with the test UI; and updating the indication based on the user input.

Example 11. A computer-implemented method of evaluating control interfaces based on user interactions in simulated and actual environments, comprising: displaying, on a display, a simulated environment user interface (UI) to a user, wherein the simulated environment UI represents a test UI of a vehicle; receiving, from one or more sensors, signals indicative of a first user interaction with the displayed simulated environment UI; calculating a plurality of parameters of the simulated environment UI based on the received signals indicative of the first user interaction, wherein the plurality of parameters comprise one or more of: a total eyes off road time metric, a task completion time, a subtask completion time, or a predictive score; displaying, on the display or a second display, an actual environment UI to the user, wherein the displayed actual environment UI corresponds to the displayed simulated environment UI, and wherein the actual environment UI is the test UI of the vehicle; receiving, from one or more sensors, signals indicative of a second user interaction with the displayed actual environment UI; calculating a second plurality of parameters of the actual environment UI based on the received signals indicative of the second user interaction, wherein the second plurality of parameters comprise one or more of: a total eyes off road time metric, a task completion time, a subtask completion time, or a predictive score; comparing the first plurality of parameters to the second plurality of parameters; and outputting an indication for one or both of the simulated or actual environment UI.

Example 12. The computer-implemented method of any one of the preceding examples, but particularly Example 11, further comprising calculating a plurality of user parameters for the user of the actual environment UI.

Example 13. The computer-implemented method of any one of the preceding examples, but particularly Example 12, wherein the plurality of user parameters comprise: a posture, a fatigue, a visual interaction pattern, an auditory interaction pattern, a tactile interaction pattern, or a combination thereof.

Example 14. The computer-implemented method of any one of the preceding examples, but particularly Example 13, further comprising calculating a readiness of the user for interaction with the actual environment UI based on the calculated plurality of parameters.

Example 15. The computer-implemented method of any one of the preceding examples, but particularly Example 14, further comprising displaying, on the display or the second display, an updated actual environment UI when the readiness of the user exceeds a predetermined threshold.

Example 16. The computer-implemented method of any one of the preceding examples, but particularly Example 11, wherein the indication comprises a user interface quality indicator of the displayed actual environment UI based on the second user interaction with the displayed actual environment UI.

Example 17. The computer-implemented method of any one of the preceding examples, but particularly Example 11, wherein the display or the second display comprise a virtual reality headset, a mobile device display, a laptop display, or a desktop display.

Example 18. The computer-implemented method of any one of the preceding examples, but particularly Example 11, wherein the first or the second user interaction comprises one or more of: a user touch, a user look, a user voice, a user bodily movement, or a user posture.

Example 19. The computer-implemented method of any one of the preceding examples, but particularly Example 11, wherein the one or more sensors are integrated into one or more of: eye tracking glasses, microphone, a dashboard-mountable camera, a seat-mountable camera, a vehicle-mountable camera, a user-mountable camera, a display mountable camera, or a display-mountable camera.

Example 20. The computer-implemented method of any one of the preceding examples, but particularly Example 11, further comprising calculating a relative probability that one or both of the displayed simulated environment UI or the actual environment UI meet or exceed a predefined safety threshold.

Example 21. A computer-implemented method of simulating user interaction with control interfaces, comprising: displaying, on a display, a simulated environment user interface (UI) to a user, wherein the simulated environment UI represents a test UI of a vehicle; receiving, from one or more sensors, signals indicative of a first user interaction with the displayed simulated environment UI; calculating a plurality of parameters of the simulated environment UI based on the received signals indicative of the first user interaction, wherein the plurality of parameters comprises: one or more of: a total eyes off UI time metric, a task completion time, a subtask completion time, or a performance score; and outputting an indication for the actual user interface.

Example 22. The computer-implemented method of any one of the preceding examples, but particularly Example 21, further comprising outputting a prediction of one or more metrics of an actual user interaction with an actual environment UI, that corresponds to the simulated environment UI, based on the calculated plurality of parameters, wherein the actual environment UI is the test UI of the vehicle.

Example 23. The computer-implemented method of any one of the preceding examples, but particularly Example 21, further comprising calculating a second plurality of parameters for the user of the simulated environment UI.

Example 24. The computer-implemented method of any one of the preceding examples, but particularly Example 23, wherein the second plurality of parameters comprise: a posture, a fatigue, a visual interaction pattern, an auditory interaction pattern, a tactile interaction pattern, or a combination thereof.

Example 25. The computer-implemented method of any one of the preceding examples, but particularly Example 21, wherein the displayed simulated environment UI comprises a distraction UI and a task UI, such the method comprises displaying a task for completion on the task UI while displaying a distraction on the distraction UI.

Example 26. The computer-implemented method of any one of the preceding examples, but particularly Example 25, wherein the distraction UI is configured to display one or more of: simulated weather conditions, simulated road conditions, or simulated location conditions.

Example 27. The computer-implemented method of any one of the preceding examples, but particularly Example 25, wherein the total eyes off UI metric is a total eye off task UI metric or a total eye on distraction UI metric.

Example 28. The computer-implemented method of any one of the preceding examples, but particularly Example 21, further comprising receiving a user input of a make and model of the vehicle that is associated with the test UI; and updating the indication based on the user input.

As used in the description and claims, the singular form “a”, “an” and “the” include both singular and plural references unless the context clearly dictates otherwise. For example, the term “sensor” may include, and is contemplated to include, a plurality of sensors. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the devices, systems, and methods include the recited elements, and may additionally include any other elements. “Consisting essentially of” shall mean that the devices, systems, and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed disclosure. “Consisting of” shall mean that the devices, systems, and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method of evaluation a control interface based on user interaction, comprising:
displaying, on a display, an actual environment user interface (UI) to a user, wherein the actual environment UI is a test UI of a vehicle;
receiving, from one or more sensors, signals indicative of a first user interaction with the displayed actual environment UI;
calculating a plurality of parameters of the first user interaction with the actual environment UI based on the received signals indicative of the first user interaction, wherein the plurality of parameters comprises one or more of: a total eyes off road time metric, a task completion time, a subtask completion time, or a performance score; and
outputting an indication for the actual user interface.

2. The computer-implemented method of claim 1, wherein the indication comprises a performance indication of a feature of the actual environment UI.

3. The computer-implemented method of claim 1, wherein the indication comprises a recommendation.

4. The computer-implemented method of claim 3, wherein the recommendation comprises a UI feature replacement, a UI feature elimination, a subtask modification, or a combination thereof.

5. The computer-implemented method of claim 1, wherein the one or more sensors are integrated into one or more of: eye tracking glasses, microphone, a user-mountable camera, a seat-mountable camera, or a display-mountable camera.

6. The computer-implemented method of claim 1, further comprising outputting a guidance to the user to position the one or more sensors so that the one or more sensors are configured to capture the first user interaction with the displayed actual environment UI.

7. The computer-implemented method of claim 1, further comprising triangulating, using the signals, an eye position of the user; and determining the first user interaction based on the triangulation, wherein the first user interaction is a visual interaction.

8. The computer-implemented method of claim 1, wherein the one or more sensors comprise a plurality of cameras, such that the method further comprises capturing a light interval, with the plurality of cameras, from a periodic light source; and
synchronizing the plurality of cameras based on the captured light interval.

9. The computer-implemented method of claim 1, wherein the displayed actual environment UI comprises a task UI, such the method comprises displaying a task for completion on the task UI.

10. The computer-implemented method of claim 1, further comprising receiving a user input of a make and model of the vehicle that is associated with the test UI; and updating the indication based on the user input.

11. A computer-implemented method of simulating user interaction with control interfaces, comprising:
displaying, on a display, a simulated environment user interface (UI) to a user, wherein the simulated environment UI represents a test UI of a vehicle;
receiving, from one or more sensors, signals indicative of a first user interaction with the displayed simulated environment UI;
calculating a plurality of parameters of the simulated environment UI based on the received signals indicative of the first user interaction, wherein the plurality of parameters comprises: one or more of: a total eyes off UI time metric, a task completion time, a subtask completion time, or a performance score; and
outputting an indication for the simulated environment UI.

12. The computer-implemented method of claim 11, further comprising outputting a prediction of one or more metrics of an actual user interaction with an actual environment UI, that corresponds to the simulated environment UI, based on the calculated plurality of parameters, wherein the actual environment UI is the test UI of the vehicle.

13. The computer-implemented method of claim 11, further comprising calculating a second plurality of parameters for the user of the simulated environment UI.

14. The computer-implemented method of claim 13, wherein the second plurality of parameters comprise: a posture, a fatigue, a visual interaction pattern, an auditory interaction pattern, a tactile interaction pattern, or a combination thereof.

15. The computer-implemented method of claim 11, wherein the displayed simulated environment UI comprises a distraction UI and a task UI, such the method comprises displaying a task for completion on the task UI while displaying a distraction on the distraction UI.

16. The computer-implemented method of claim 15, wherein the distraction UI is configured to display one or more of: simulated weather conditions, simulated road conditions, or simulated location conditions.

17. The computer-implemented method of claim 15, wherein the total eyes off UI metric is a total eye off task UI metric or a total eye on distraction UI metric.

18. The computer-implemented method of claim 11, further comprising receiving a user input of a make and model of the vehicle that is associated with the test UI; and updating the indication based on the user input.
